(19) United States
(12) Patent Application Publication
(10) Pub. No.: US 2026/0321612 A1
(43) Pub. Date: Oct. 15, 2026

(54) SOLID-STATE BATTERY CELLS INCLUDING ANODE ELECTRODES WITH FERROSILICON MICROPARTICLES

(71) Applicant: GM GLOBAL TECHNOLOGY OPERATIONS LLC, Detroit, MI (US)

(72) Inventors: Qili SU, Shanghai (CN); Zhe LI, Shanghai (CN); Haijing LIU, Shanghai (CN)

(21) Appl. No.: 19/467,233

(22) Filed: Feb. 2, 2026

(30) Foreign Application Priority Data
Feb. 14, 2025 (CN) 2025101658280

(51) Int. Cl. H01M 4/38; H01M 4/134; H01M 4/62; H01M 50/46; B60L 50/64

(52) U.S. Cl. CPC H01M 4/386; H01M 4/134; H01M 4/62; H01M 50/46; B60L 50/64

(57) ABSTRACT

A solid-state battery cell includes C cathode electrodes including a cathode active material layer arranged on a cathode current collector, S separators, and A anode electrodes including an anode active material layer arranged on an anode current collector, where C, A, and S are integers. The anode active material layer includes ferrosilicon microparticles including a silicon framework and embedded ferrosilicon domains. The ferrosilicon microparticles may be produced by cleaning and crushing ferrosilicon rock to produce crushed ferrosilicon. The crushed ferrosilicon is milled to produce ferrosilicon microparticles. The ferrosilicon microparticles are separated from the crushed ferrosilicon using a sieve. The ferrosilicon microparticles include a silicon framework and embedded ferrosilicon domains. The ferrosilicon microparticles are mixed with a binder. The anode electrode includes the ferrosilicon microparticles and the binder.

### CROSS-REFERENCE TO RELATED APPLICATIONS

This application claims the benefit of Chinese Patent Application No. 202510165828.0, filed on Feb. 14, 2025. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to solid-state battery cells, and more particularly to solid-state battery cells including an anode electrode with ferrosilicon microparticles.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer arranged on a cathode current collector. The anode electrodes include an anode active material layer arranged on an anode current collector.

### SUMMARY

A solid-state battery cell includes C cathode electrodes including a cathode active material layer arranged on a cathode current collector, S separators, and A anode electrodes including an anode active material layer arranged on an anode current collector, where C, A, and S are integers. The anode active material layer includes ferrosilicon microparticles including a silicon framework and embedded ferrosilicon domains.

In other features, the anode active material layer includes the ferrosilicon microparticles, a sulfide electrolyte, and a binder. The anode active material layer includes the ferrosilicon microparticles and a binder. The silicon framework has a particle size in a range from 0.3 micrometers (μm) to 10 μm. The embedded ferrosilicon domains are in a range from 5 nanometers (nm) to 100 nm. The embedded ferrosilicon domains are selected from a group consisting of a FeSi phase, a FeSi2 phase, a Fe5Si3 phase, and combinations thereof.

In other features, the A anode active material has a capacity greater than 1500 mAh/g. The ferrosilicon microparticles have a composition of silicon:iron:X, where silicon (Si) is in a range from 50 wt% to 98 wt%, iron (Fe) is in a range from 2 wt% to 50% wt%, and X includes one or more materials in a range from 0 wt% to 5 wt%. X includes one or more materials in a range from 0.3 wt% to 5 wt% and is selected from a group consisting of boron (B), aluminum (Al), calcium (Ca), nickel (Ni), copper (Cu), manganese (Mn), and combinations thereof. X includes one or more materials in a range from 0.3 wt% to 5 wt% and is selected from a group consisting of boron (B) comprising less than 1 wt%, aluminum (Al) comprising less than 2 wt%, calcium (Ca) comprising less than 1.5 wt%, nickel (Ni) comprising less than 0.4 wt%, copper (Cu) comprising less than 0.4 wt%, and manganese (Mn) comprising less than 0.4 wt%.

A method for manufacturing a battery cell includes cleaning and crushing ferrosilicon rock to produced crushed ferrosilicon; milling the crushed ferrosilicon; separating ferrosilicon microparticles from the crushed ferrosilicon using a sieve, wherein the ferrosilicon microparticles include a silicon framework and embedded ferrosilicon domains; mixing the ferrosilicon microparticles with a binder; forming an anode electrode including an anode active material layer including the ferrosilicon microparticles and the binder on an anode current collector; and arranging the anode electrode in a battery cell.

In other features, the battery cell further includes C cathode electrodes including a cathode active material layer arranged on a cathode current collector, S separators, and A of the anode electrode, where C, A, and S are integers. The anode active material layer further includes a sulfide electrolyte. The silicon framework has a particle size in a range from 0.3 micrometers (μm) to 10 μm. The embedded ferrosilicon domains are in a range from 5 nanometers (nm) to 100 nm.

In other features, the embedded ferrosilicon domains are selected from a group consisting of FeSi phase, FeSi2 phase, Fe5Si3 phase, and combinations thereof. The A anode active material has a capacity greater than 1500 mAh/g.

In other features, the ferrosilicon microparticles have a composition of silicon:iron:X, where silicon (Si) is in a range from 50 wt% to 98 wt%, iron (Fe) is in a range from 2 wt% to 50% wt%, and X includes one or more materials in a range from 0 wt% to 5wt%. X includes one or more materials in a range from 0.3 wt% to 5wt% and is selected from a group consisting of boron (B), aluminum (Al), calcium (Ca), nickel (Ni), copper (Cu), manganese (Mn), and combinations thereof. X includes one or more materials in a range from 0.3 wt% to 5wt% and is selected from a group consisting of boron (B) comprising less than 1 wt%, aluminum (Al) comprising less than 2 wt%, calcium (Ca) comprising less than 1.5wt%, nickel (Ni) comprising less than 0.4 wt%, copper (Cu) comprising less than 0.4 wt%, and manganese (Mn) comprising less than 0.4 wt%.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross section of an example of a solid-state battery cell including C cathode electrodes, S separators, and A anode electrodes including ferrosilicon microparticles according to the present disclosure;

FIG. 2A is a side cross section of an example of one of the C cathode electrodes, one of the A anode electrodes including ferrosilicon microparticles, and one of the S separators of the solid-state battery cell according to the present disclosure;

FIGS. 2B and 2C are side cross sections of an example of one of the A anode electrodes according to the present disclosure;

FIG. 3A is a side cross section of an example of one of the C cathode electrodes, one of the A anode electrodes including ferrosilicon microparticles, and one of the S separators of the solid-state battery cell according to the present disclosure;

FIGS. 3B and 3C are side cross sections of an example of one of the A anode electrodes according to the present disclosure;

FIG. 4 is a flowchart for a method for manufacturing ferrosilicon microparticles according to the present disclosure;

FIG. 5 is a graph illustrating an example of a composition of the ferrosilicon before and after the method in FIG. 4;

FIG. 6 is a graph illustrating an example of voltage and capacity during a first cycle at 0.1C and room temperature for solid-state battery cells including anode electrodes with pure silicon and ferrosilicon microparticles, respectively;

FIG. 7 is a graph illustrating an example of voltage and capacity during a cycle at 0.5C and room temperature for solid-state battery cells including anode electrodes with pure silicon and ferrosilicon microparticles, respectively; and

FIG. 8 is a graph illustrating an example of cycling performance at room temperature for solid-state battery cells including anode electrodes with pure silicon and ferrosilicon microparticles, respectively.

In the drawings, reference numbers may be reused to identify similar and/or identical elements.

### DETAILED DESCRIPTION

While solid-state battery cells are described herein in the context of vehicles, the solid-state battery cells can be used in other types of mobile applications and/or stationary applications.

Silicon (Si) has emerged as a promising alternative to graphite-based anode electrodes since it is environmentally benign, has reasonable electrochemical potential (~0.3V vs. Li/Li⁺), and a high theoretical capacity (4200 mAh/g for Li_{4.4}Si). However, Si anode electrodes suffer from large volumetric expansion during charging. Furthermore, nano-sized battery grade silicon with greater than 99% (2N) or 99.9% (3N) purity is expensive. The nano-sized silicon particles may also be coated with carbon. When carbonate-based electrolyte is used, battery cell cycling is adversely impacted.

The present disclosure relates to all-solid-state battery cells comprising anode electrodes including an anode active material layer incorporating ferrosilicon microparticles. The ferrosilicon microparticles comprise a silicon framework with nano-sized Fe_{y}Siₓ domains.

The ferrosilicon microparticles are prepared using relatively low cost ferrosilicon rocks as raw material. Different grades of ferrosilicon rocks are currently available with silicon content ranging from 10 wt% to 98 wt%. The ferrosilicon rocks are selected with a predetermined silicon concentrations greater than 50 wt%. The ferrosilicon rocks are crushed and milled to reduce the size to microparticles. Material separation (e.g., such as a sieve or screen) is used to remove oversize particles.

The ferrosilicon microparticles are used in an anode active material layer of a lithium-ion battery cell. In some examples incorporating a solid electrolyte, the ferrosilicon microparticles build up a robust solid electrolyte interphase (SEI) with the solid electrolyte to enable stable cell cycling. The Fe_{y}Siₓ domains provide higher electronic conductivity and at least partially alleviate silicon expansion that occurs during cycling.

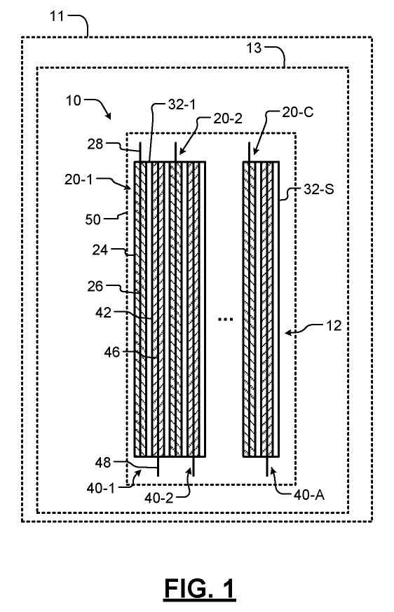

Referring now to FIG. 1, a solid-state battery cell 10 includes C cathode electrodes 20, A anode electrodes 40, and S separators 32 arranged in a predetermined sequence in a battery cell stack 12, where C, S and A are integers greater than zero. In some examples, the vehicle 11 includes a battery module or pack 13 including the solid-state battery cell 10. The battery cell stack 12 is arranged in an enclosure 50.

The C cathode electrodes 20-1, 20-2, …, and 20-C include a cathode active material layer 24 arranged on one or both sides of a cathode current collector 26. The A anode electrodes 40-1, 40-2, ..., and 40-A include an anode active material layer 42 arranged one or both sides of an anode current collector 46. The anode active material layer 42 includes ferrosilicon microparticles.

During charging/discharging, the A anode electrodes 40 and the C cathode electrodes 20 exchange lithium ions. In some examples, the cathode active material layers 24 and/or the anode active material layer 44 comprise coatings including one or more active materials, solid electrolyte, one or more conductive additives, and/or one or more binder materials that are applied to the current collectors.

In some examples, the anode current collectors 46 and/or the cathode current collectors 26 comprise metal foil, metal mesh, perforated metal, 3 dimensional (3D) metal foam, and/or expanded metal. External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells.

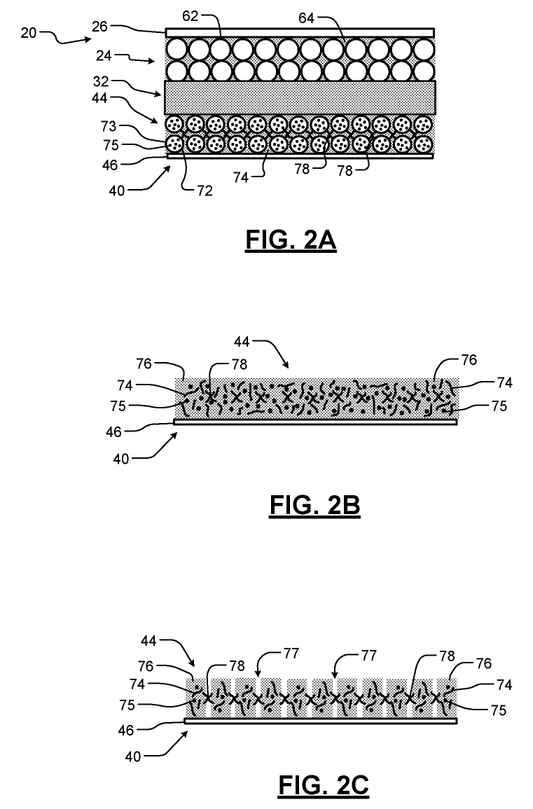

Referring now to FIGS. 2A to 2C, an example of the solid-state battery cell and one of the A anode electrodes of the solid-state battery cell are shown. In FIG. 2A, the cathode active material layer 24 of one of the C cathode electrodes 20 includes cathode active material 62 and a solid electrolyte 64. In some examples, the solid electrolyte 64 includes sulfide-based solid electrolyte (e.g., lithium silicon phosphor sulfo-chloride (LiSiPSCl)) The anode active material layer 44 of one of the A anode electrodes 40 is shown before formation to include anode active material including ferrosilicon microparticles 72 (including a silicon framework 73 and ferrosilicon Fe_{y}Siₓ domains 75) and solid electrolyte 74. In FIG. 2B, the anode electrode 40 is shown in a discharged state after formation. The anode active material layer 44 includes lithiated silicon 76, the ferrosilicon Fe_{y}Siₓ domains 75, the solid electrolyte 74, and a binder 78. In FIG. 2C, the anode electrode 40 is shown in a charged state after formation. Vertical voids 77 are formed in the anode active material layer 44.

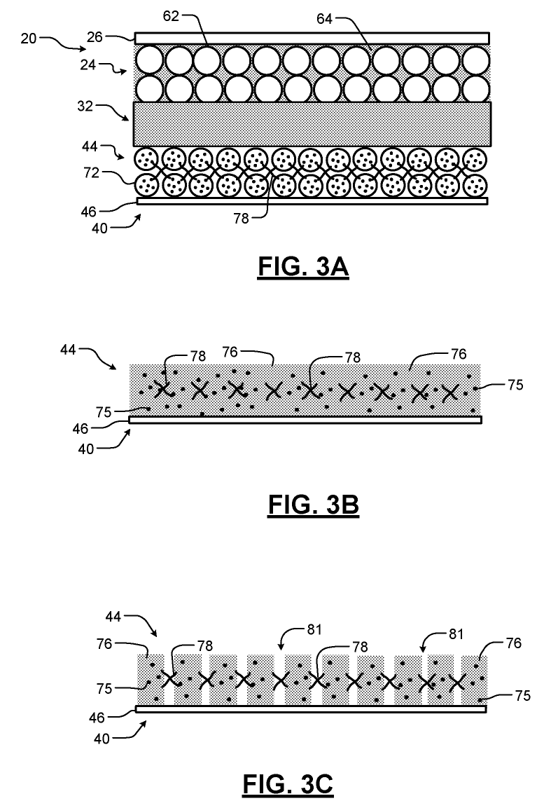

Referring now to FIGS. 3A to 3C, the anode active material layer 44 is shown to include anode active material including ferrosilicon microparticles 72 (including the silicon framework 73 and ferrosilicon Fe_{y}Siₓ domains 75) and a binder 78. In FIG. 3B, the anode electrode 40 is shown in a discharged state after formation. The anode active material layer 44 includes the lithiated silicon 76, the ferrosilicon Fe_{y}Siₓ domains 75, and the binder 79. In FIG. 3C, the anode electrode 40 is shown in a charged state after formation. Vertical voids 81 are formed in the anode active material layer 44.

In some examples, the ferrosilicon microparticles 72 have a composition silicon:iron:X where silicon (Si) is in a range from 50 wt% to 98 wt%, iron (Fe) is in a range from 2 wt% to 50% wt%, and X is in a range from 0 wt% to 5wt%. In some examples, X includes one or more materials selected from a group consisting of boron (B), aluminum (Al), calcium (Ca), nickel (Ni), copper (Cu), manganese (Mn), and combinations thereof. In some examples, boron (B) comprises less than 1 wt%, aluminum (Al) comprises less than 2 wt%, calcium (Ca) comprises less than 1.5wt%, nickel (Ni) comprises less than 0.4 wt%, copper (Cu) comprises less than 0.4 wt%, and manganese (Mn) comprises less than 0.4 wt%.

In some examples, the Fe_{y}Siₓ domains comprise a FeSi phase, a FeSi₂ phase, a Fe₅Si₃ phase, and/or combinations thereof. In some examples, the silicon framework has a particle size in a range from 0.3 μm to 10 μm (e.g., 6 μm). In some examples, the size of the Fe_{y}Siₓ domains is in a range from 5nm to 100 nm. In some examples, the anode electrodes have a capacity greater than 1500 mAh/g.

In some examples, the ferrosilicon microparticles are mixed with a sulfide solid electrolyte, and a binder (with or without a solvent) to form the anode active material layer. In some examples, the ferrosilicon microparticles are mixed with a binder (with or without a solvent) to form the anode active material layer.

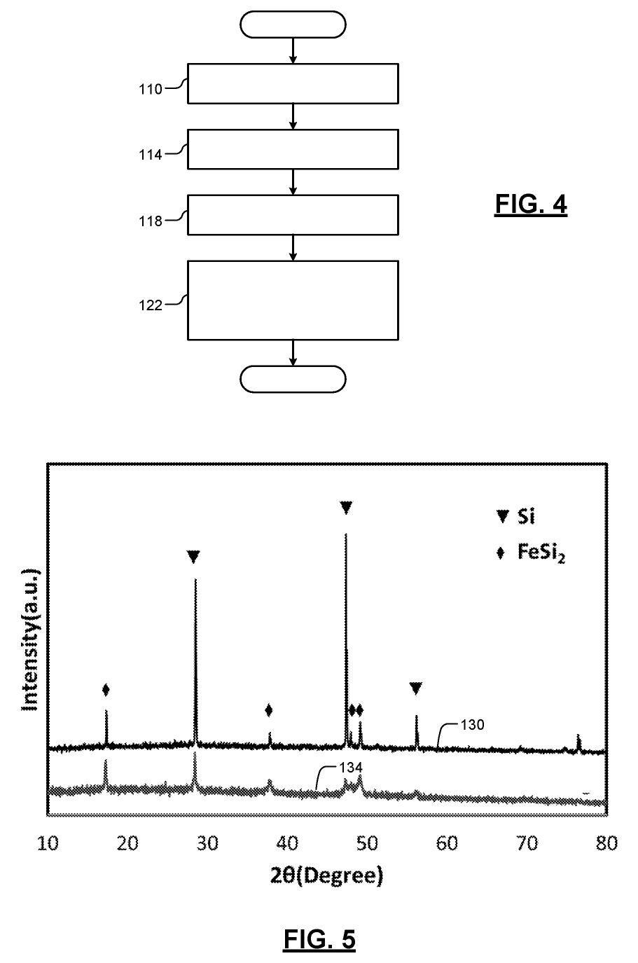

For example, SiFe7525 is a commonly-used deoxidizer and alloying additive available (e.g., in the metallurgy industry) with particle size diameters greater than 100 μm. In some examples, ferrosilicon microparticles produced using SiFe7525 have a particle size of 6 to 7 μm after ball milling with a ball to material ratio of 20:1 in ethanol at 500 rpm for 1 hour. Referring now to FIG. 5, ball milling causes a reduced peak intensity and a broader peak of silicon due to the reduced particle size (before ball milling at 130 after ball milling at 134). In this example, the ferrosilicon microparticles include Si phase or framework and a FeSi₂ phase.

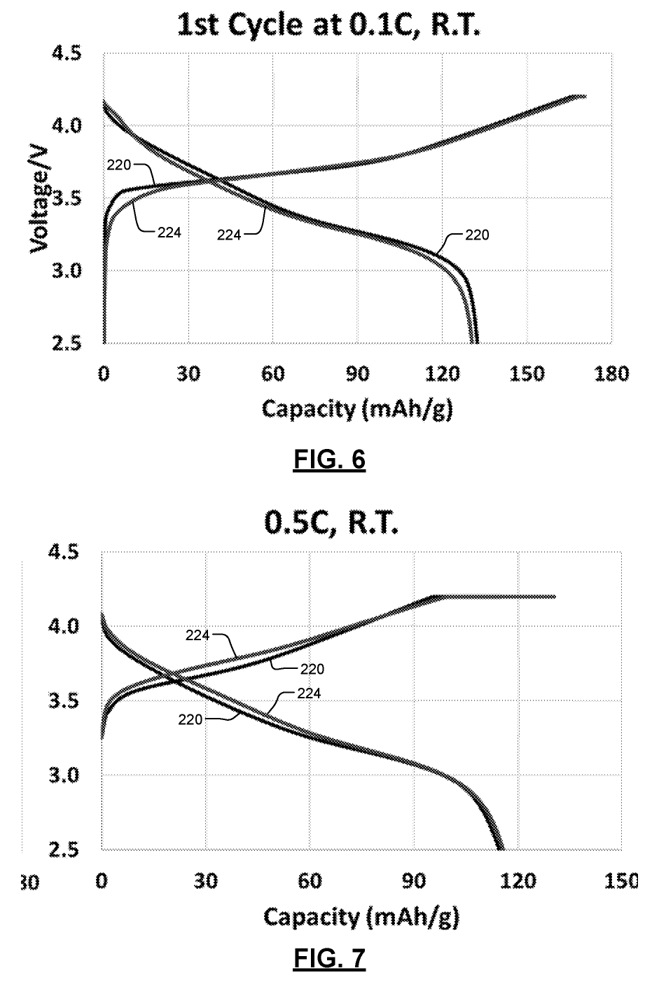

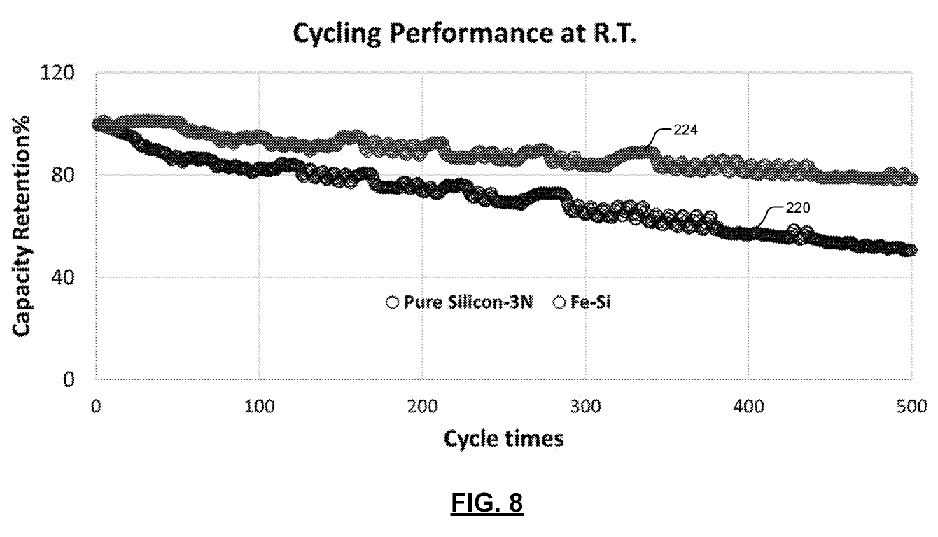

Referring now to FIGS. 6 to 8, electrochemical performance of a first battery cell at 220 including pure Si-3N (or 99.9% purity) is compared to a second battery cell at 224 including ferrosilicon microparticles (with silicon at 75 wt%) and sulfide electrolyte at a 70:30 mass ratio. In FIGS. 6 and 7, first cycle performance of the first battery cell 220 and the second battery cell 224 at 0.1C and 0.5C (at room temperature (RT)) is similar. The second battery cell 224 including the ferrosilicon microparticles has slightly lower discharge capacity (130.5 vs 132.4 mAh/g) and Coulombic efficiency (76.6 % vs 78.6%), and slightly higher rater performance (0.5C/0.1C retention ,88.7% vs 86.4%). In FIG. 8, capacity retention is shown for the first battery cell 220 and the second battery cell 224. The second battery cell 224 shows improved capacity retention.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

What is claimed is:

1. A solid-state battery cell comprising:
C cathode electrodes including a cathode active material layer arranged on a cathode current collector;
S separators; and
A anode electrodes including an anode active material layer arranged on an anode current collector,
where C, A, and S are integers, and
wherein the anode active material layer includes ferrosilicon microparticles including a silicon framework and embedded ferrosilicon domains.

2. The solid-state battery cell of claim 1, wherein the anode active material layer includes the ferrosilicon microparticles, a sulfide electrolyte, and a binder.

3. The solid-state battery cell of claim 1, wherein the anode active material layer includes the ferrosilicon microparticles and a binder.

4. The solid-state battery cell of claim 1, wherein the silicon framework has a particle size in a range from 0.3 micrometers (μm) to 10 μm.

5. The solid-state battery cell of claim 1, wherein the embedded ferrosilicon domains are in a range from 5 nanometers (nm) to 100 nm.

6. The solid-state battery cell of claim 1, wherein the embedded ferrosilicon domains are selected from a group consisting of a FeSi phase, a FeSi₂ phase, a Fe₅Si₃ phase, and combinations thereof.

7. The solid-state battery cell of claim 1, wherein the A anode active material have a capacity greater than 1500 mAh/g.

8. The solid-state battery cell of claim 1, wherein the ferrosilicon microparticles have a composition of silicon:iron:X, where silicon (Si) is in a range from 50 wt% to 98 wt%, iron (Fe) is in a range from 2 wt% to 50% wt%, and X includes one or more materials in a range from 0 wt% to 5 wt%.

9. The solid-state battery cell of claim 8, wherein X includes one or more materials in a range from 0.3 wt% to 5 wt% and is selected from a group consisting of boron (B), aluminum (Al), calcium (Ca), nickel (Ni), copper (Cu), manganese (Mn), and combinations thereof.

10. The solid-state battery cell of claim 8, wherein X includes one or more materials in a range from 0.3 wt% to 5 wt% and is selected from a group consisting of boron (B) comprising less than 1 wt%, aluminum (Al) comprising less than 2 wt%, calcium (Ca) comprising less than 1.5 wt%, nickel (Ni) comprising less than 0.4 wt%, copper (Cu) comprising less than 0.4 wt%, and manganese (Mn) comprising less than 0.4 wt%.

11. A method for manufacturing a battery cell, comprising:
cleaning and crushing ferrosilicon rock to produced crushed ferrosilicon;
milling the crushed ferrosilicon;
separating ferrosilicon microparticles from the crushed ferrosilicon using a sieve, wherein the ferrosilicon microparticles include a silicon framework and embedded ferrosilicon domains;
mixing the ferrosilicon microparticles with a binder;
forming an anode electrode including an anode active material layer including the ferrosilicon microparticles and the binder on an anode current collector; and
arranging the anode electrode in a battery cell.

12. The method of claim 11, wherein the anode active material layer further includes a sulfide electrolyte.

13. The method of claim 11, wherein the silicon framework has a particle size in a range from 0.3 micrometers (μm) to 10 μm.

14. The method of claim 11, wherein the embedded ferrosilicon domains are in a range from 5 nanometers (nm) to 100 nm.

15. The method of claim 11, wherein the embedded ferrosilicon domains are selected from a group consisting of FeSi phase, FeSi₂ phase, Fe5Si₃ phase, and combinations thereof.

16. The method of claim 11, wherein the A anode active materials have a capacity greater than 1500 mAh/g.

17. The method of claim 11, wherein the ferrosilicon microparticles have a composition of silicon:iron:X, where silicon (Si) is in a range from 50 wt% to 98 wt%, iron (Fe) is in a range from 2 wt% to 50% wt%, and X includes one or more materials in a range from 0 wt% to 5wt%.

18. The method of claim 17, wherein X includes one or more materials in a range from 0.3 wt% to 5wt% and is selected from a group consisting of boron (B), aluminum (Al), calcium (Ca), nickel (Ni), copper (Cu), manganese (Mn), and combinations thereof.

19. The method of claim 17, wherein X includes one or more materials in a range from 0.3 wt% to 5wt% and is selected from a group consisting of boron (B) comprising less than 1 wt%, aluminum (Al) comprising less than 2 wt%, calcium (Ca) comprising less than 1.5wt%, nickel (Ni) comprising less than 0.4 wt%, copper (Cu) comprising less than 0.4 wt%, and manganese (Mn) comprising less than 0.4 wt%.

20. A battery cell comprising:
C cathode electrodes including a cathode active material layer arranged on a cathode current collector;
S separators; and
A anode electrodes including an anode active material layer arranged on an anode current collector,
where C, A, and S are integers,
wherein the battery cell is a solid-state battery cell,
wherein the anode active material layer includes ferrosilicon microparticles having a composition of silicon:iron:X, where silicon (Si) is in a range from 50 wt% to 98 wt%, iron (Fe) is in a range from 2 wt% to 50% wt%, and X includes one or more materials in a range from 0 wt% to 5 wt%, and
wherein the ferrosilicon microparticles include a silicon framework having a particle size in a range from 0.3 micrometers (μm) to 10 μm and embedded ferrosilicon domains selected from a group consisting of a FeSi phase, a FeSi₂ phase, a Fe₅Si₃ phase, and combinations thereof in a range from 5 nanometers (nm) to 100 nm.
